(19) United States
(12) Patent Application Publication
(10) Pub. No.: US 2013/0342744 A1
(43) Pub. Date: Dec. 26, 2013

(54) SOLID-STATE IMAGING DEVICE, METHOD OF DRIVING THE SAME, AND ELECTRONIC APPARATUS

(71) Applicant: Sony Corporation, Tokyo (JP)

(72) Inventors: Haruhisa Naganokawa, Kanagawa (JP); Kenya Kondou, Fukuoka (JP); Kandai Fukuyama, Kanagawa (JP)

(73) Assignee: SONY CORPORATION, Tokyo (JP)

(21) Appl. No.: 13/903,045

(22) Filed: May 28, 2013

(30) Foreign Application Priority Data
Jun. 26, 2012 (JP) 2012-142959

(51) Int. Cl. H04N 5/353

(52) U.S. Cl. CPC H04N 5/353
USPC 348/297

(57) ABSTRACT

A solid-state imaging device includes: a photoelectric conversion section configured to perform photoelectric conversion on incident light, and to store obtained photoelectric charge; a voltage conversion section configured to convert the photoelectric charge transferred from the photoelectric conversion section into a voltage signal; a first gate section configured to transfer the photoelectric charge stored in the photoelectric conversion section to the voltage conversion section; a second gate section configured to reset a potential of the voltage conversion section; a third gate section configured to directly reset the photoelectric charge stored in the photoelectric conversion section; and a control section configured to control driving of the first to the third gate sections, wherein the control section controls driving of the third gate section so as to adjust an exposure time of the photoelectric conversion section.

### BACKGROUND

The present disclosure relates to a solid-state imaging device, a method of driving the solid-state imaging device, and an electronic apparatus. In particular, the present disclosure relates to a solid-state imaging device, a method of driving the solid-state imaging device, and an electronic apparatus that are capable of adjusting a shortest exposure time freely.

In a CMOS image sensor (hereinafter, referred to as a CIS for short) as a solid-state imaging device, which is used for a digital still camera, and so on, if an exposure time period is not properly adjusted, deterioration may occur in an image to be captured. For example, at the time of shooting a high-luminance subject, if it is difficult to shorten an exposure time period, a pixel signal level reaches the upper limit of the dynamic range of the signal, and the image becomes whitish on the whole.

In this regard, in order to cope with a high-luminance subject, in addition to a method of shortening the exposure time period, there is a method of physically increasing a unit pixel capacitance (capacitance for storing a photoelectric charge produced by photoelectric conversion and FD (Floating Diffusion) capacitance).

It has been difficult to cope with the above-described problem by the former method because of the structure of the CIS. Specifically, it is difficult to perform pixel reset, which becomes start timing of an exposure time period during a period of reading a pixel reset potential (FD reset potential), and thus it has been difficult to shorten the exposure time period freely.

Here, a more detailed description will be given of the reason that it is difficult to shorten the exposure time period freely.

FIG. 1 illustrates an example of a configuration of a related-art CIS. The CIS 10 includes an AD conversion section (hereinafter, referred to as an ADC), which performs a correlated double sampling (hereinafter referred to as CDS) method for eliminating noise that might arise on a pixel signal as digital signal processing (for example, refer to Japanese Patent No. 4107269).

The CIS 10 includes a pixel array section 11, a row scanning section 12, a column scanning section 13, a timing control section 14, an ADC 15 disposed for each column, a DAC 16, and a data output section 17.

The pixel array section 11 includes a large number of unit pixels 111 disposed in a matrix state. The row scanning section 12 to the timing control section 14 read signals of the pixel array section 11 in sequence. The row scanning section 12 controls a row address and row scanning. The column scanning section 13 controls a column address and column scanning. The timing control section 14 generates an internal clock.

Each ADC 15 is an integral ADC including a comparator (CMP) 151, an asynchronous up/down counter (CNT) 152, and a switch 153.

The comparator 151 compares a reference voltage Vref′ produced by the DAC 16 and an analog voltage signal VSL′ corresponding to the photoelectric charge read from the unit pixel 111 through a vertical signal line Vn (n=0, 1 . . . , n+1), and outputs a comparison result thereof to the asynchronous up/down counter (hereinafter, referred to as a counter for short) 152.

The counter 152 has a function of receiving the comparison result of the comparator 151 and a clock CK to perform up/down count (or down count), and holding a count value as a result. The switch 153 connects the counter 152 and a data transfer line 18, and is turned on or off by scan control from the column scanning section 13. The data output section 17 including a sense circuit corresponding to the data transfer line 18 and a subtraction circuit is disposed on the data transfer line 18.

The counter 152 having a function as a holding circuit is in an up-count (or down-count) state at initial time, and performs reset count. When the comparison result from the corresponding comparator 151 is inverted, the up-count operation is stopped, and the count value is held. At this time, the initial value of the counter 152 is set to any value of an AD conversion grayscale, for example, 0. During the reset count period, a reset component of the unit pixel 111 is read. After that, the counter 152 becomes the down-count (or up-count) state, and performs data count corresponding to the amount of incident light. When the comparison result of the corresponding comparator 151 is inverted, a count value corresponding to the comparison period is held. The counter value held in the counter 152 is input into the data output section 17 as a digital signal through the switch 153 closed in response to scanning by the column scanning section 13 and the data transfer line 18.

The column scanning section 13 is activated by the timing control section 14 supplying a start pulse STR and a master clock MCK, for example. The column scanning section 13 drives a corresponding selection line SEL in synchronism with a drive clock CLK based on the master clock MCK, and reads the latch data (the held count value) of the counter 152 onto the data transfer line 18.

Next, FIG. 2 illustrates an example of a configuration of the unit pixel 111.

The unit pixel 111 includes a photodetector (hereinafter referred to as a PD) 121, a diffusion layer (hereinafter referred to as a FD) 122, a transfer gate transistor (hereinafter referred to as a TRG Tr) 123, a reset transistor (hereinafter referred to as a RST Tr) 124, an amplification transistor (hereinafter referred to as an Amp Tr) 125, and a selection transistor (hereinafter referred to as a SEL Tr) 126.

The PD 121 performs photoelectric conversion on incident light to generate a photoelectric charge, and stores the photoelectric charge. The FD 122 performs voltage conversion on the photoelectric charge transferred from the PD 121 through the TRG Tr 123. The TRG Tr 123 transfers the photoelectric charge stored in the PD 121 to the FD 122 under the control of the timing control section 14. The RST Tr 124 resets the potential of the FD 122 under the control of the timing control section 14.

The Amp Tr 125 amplifies the potential of the FD 122 under the control of the timing control section 14. The SEL Tr 126 outputs a voltage signal indicating the amplified potential of the FD 122 to the vertical signal line Vn under the control of the timing control section 14.

FIG. 3 illustrates an example of an operation waveform of the unit pixel 111.

In the CIS 10, the following processing is performed in one horizontal unit period (1H). Also, in order to prevent randomization, a pixel signal level is read after a pixel reset level is read without fail.

That is to say, in 1H, first reading of a unit pixel 111 in any row Hx onto the vertical signal line Vn (n=0, 1, . . . , n+1), first comparison by the comparator 151, and counting by the counter 152 are performed as a P phase (reset period). Next, second reading, second comparison by the comparator 151, counting by the counter 152, and the post processing are performed as a D phase (signal read period). And a result produced when the first count value is subtracted from the second count value is output as a pixel signal.

In this regard, the timing of the P phase and the D phase is controlled by the timing control section 14.

FIG. 4 illustrates an example of an operation waveform of the unit pixel 111 in the case of shooting a high-luminance subject.

A shutter operation in the unit pixel 111 is started by turning the TRG Tr 123 and the RST Tr 124 High at the same time to reset the PD 121. After that, the shutter operation is terminated by turning at least the TRG Tr 123 Low.

In this regard, the RST Tr 124 is turned High so that the FD 122 is reset. After that, in a state in which the RST Tr 124 is Low, the pixel reset level is read. After that, the TRG Tr 123 is turned High so that the photoelectric charge stored in the PD 121 is transferred to the FD 122 to read the image signal level.

### SUMMARY

As described above, it is necessary to reset the PD 121 at the start of a shutter time (that is to say, an exposure time period) of the unit pixel 111. In order to do so, it is necessary to turn the TRG Tr 123 and the RST Tr 124 High at the same time. Also, at the end of the exposure time period, it is necessary to turn at least the TRG Tr 123 Low. During the period from when the TRG Tr 123 is turned High once and then turned High again, a pixel reset level is read.

To put it in another way, a read period of the pixel reset level becomes the exposure time period, and thus in the unit pixel 111, it has been difficult to set the exposure time period which is shorter than the read period of the pixel reset level.

Accordingly, in the case of a high-luminance subject, it is difficult to suitably adjust the exposure time period to be shortened, and thus an image signal fails to ensure the dynamic range (is saturated). Thereby, deterioration sometimes occurs in the quality of a shot image.

The present disclosure has been made in view of these circumstances. It is desirable to suitably adjust the exposure time period of the unit pixel.

According to an embodiment of the present disclosure, there is provided a solid-state imaging device including: a photoelectric conversion section configured to perform photoelectric conversion on incident light, and to store obtained photoelectric charge; a voltage conversion section configured to convert the photoelectric charge transferred from the photoelectric conversion section into a voltage signal; a first gate section configured to transfer the photoelectric charge stored in the photoelectric conversion section to the voltage conversion section; a second gate section configured to reset a potential of the voltage conversion section; a third gate section configured to directly reset the photoelectric charge stored in the photoelectric conversion section; and a control section configured to control driving of the first to the third gate sections, wherein the control section controls driving of the third gate section so as to adjust an exposure time of the photoelectric conversion section.

The control section may be configured to set the third gate section to Low in order to start the exposure time of the photoelectric conversion section in a pixel-reset-level read period in which the first gate section and the second gate section are at Low.

The third gate section may be controlled to be driven in accordance with luminance of a subject so that the exposure time of the photoelectric conversion section is adjusted.

A plurality of the photoelectric conversion sections and the first gate sections may be provided, and the voltage conversion section may add the photoelectric charges transferred from the plurality of the photoelectric conversion sections to convert the photoelectric charges into a voltage signal.

The solid-state imaging device according to the above-described embodiment may further include a color filter configured to cover a pixel array section including a large number of photoelectric conversion sections disposed in a matrix, wherein the color filter may include a white color.

The photoelectric conversion section may be disposed on an AF line sensor.

According to another embodiment of the present disclosure, there is provided a method of driving a solid-state imaging device including a photoelectric conversion section configured to perform photoelectric conversion on incident light, and to store obtained photoelectric charge, a voltage conversion section configured to convert the photoelectric charge transferred from the photoelectric conversion section into a voltage signal, a first gate section configured to transfer the photoelectric charge stored in the photoelectric conversion section to the voltage conversion section, a second gate section configured to reset a potential of the voltage conversion section, a third gate section configured to directly reset the photoelectric charge stored in the photoelectric conversion section, and a control section configured to control driving of the first to the third gate sections, the method including: by the control section, setting the first gate section and the second gate section to Low to dispose a read period of a pixel reset level; and setting the third gate section to Low in the read period of the pixel reset level in order to start an exposure time of the photoelectric conversion section.

According to another embodiment of the present disclosure, there is provided an electronic apparatus including an imaging section using a solid-state imaging device, the solid-state imaging device including: a photoelectric conversion section configured to perform photoelectric conversion on incident light, and to store obtained photoelectric charge; a voltage conversion section configured to convert the photoelectric charge transferred from the photoelectric conversion section into a voltage signal; a first gate section configured to transfer the photoelectric charge stored in the photoelectric conversion section to the voltage conversion section; a second gate section configured to reset a potential of the voltage conversion section; a third gate section configured to directly reset the photoelectric charge stored in the photoelectric conversion section; and a control section configured to control driving of the first to the third gate sections, wherein the control section controls driving of the third gate section so as to adjust an exposure time of the photoelectric conversion section.

In the embodiments according to the present disclosure, the control section controls the third gate section so as to adjust an exposure time of the photoelectric conversion sections.

By an embodiment of the present disclosure, it is possible to achieve a solid-state imaging device capable of suitably adjusting an exposure time.

By another embodiment of the present disclosure, it is possible to achieve an electronic apparatus including an imaging section capable of suitably adjusting an exposure time.

### BRIEF DESCRIPTION OF THE DRAWINGS

FIG. 1 is a block diagram illustrating an example of a configuration of a related-art CIS;

FIG. 2 is a circuit diagram illustrating an example of a configuration of a related-art unit pixel;

FIG. 3 is an operation waveform chart when a pixel signal is read from the unit pixel in FIG. 2;

FIG. 4 is an operation waveform chart in the case of shooting a subject having high luminance;

FIG. 5 is a circuit diagram illustrating an example of a configuration of a unit pixel to which the present disclosure is applied;

FIG. 6 is an operation waveform chart when a pixel signal is read from the unit pixel in FIG. 5;

FIG. 7 is a circuit diagram illustrating a variation of a unit pixel to which the present disclosure is applied;

FIG. 8 is a diagram illustrating an example of a pixel arrangement including a W pixel to which the unit pixel in FIG. 7 can be applied; and

FIG. 9 is a diagram for explaining an application of the unit pixel in FIG. 7.

### DETAILED DESCRIPTION OF EMBODIMENTS

In the following, a detailed description will be given of a best mode for carrying out the present disclosure (hereinafter referred to as an embodiment) with reference to the drawings.

### Example of Configuration of Unit Pixel

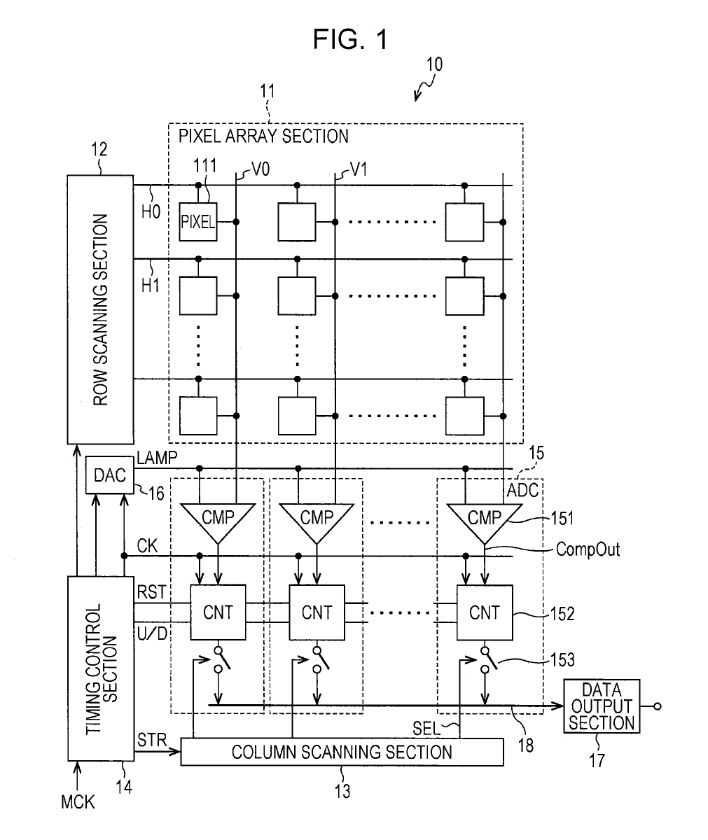

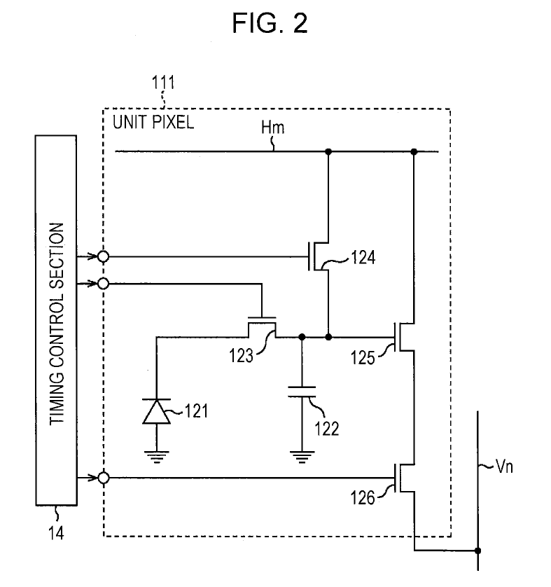

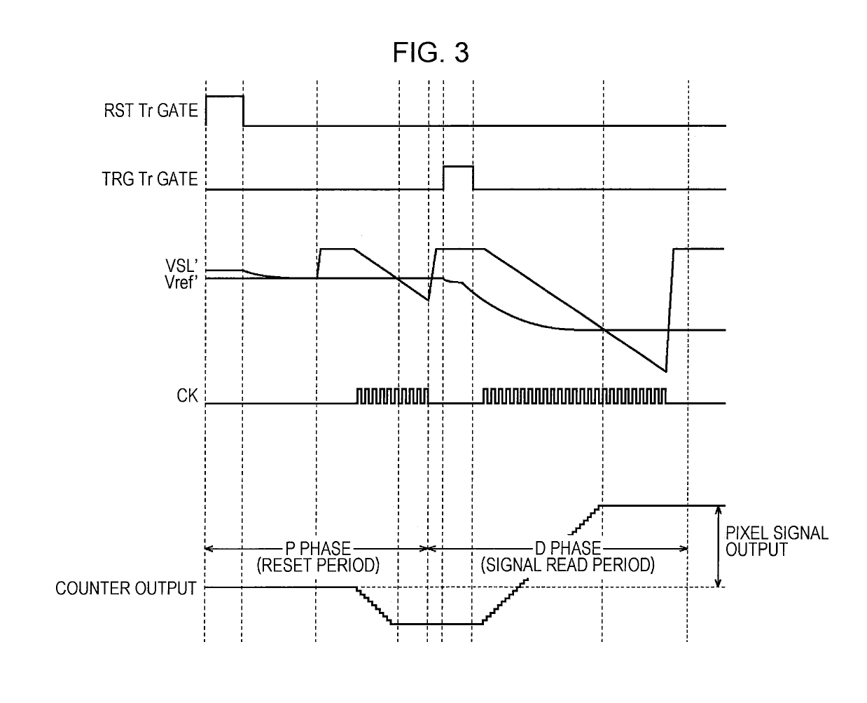

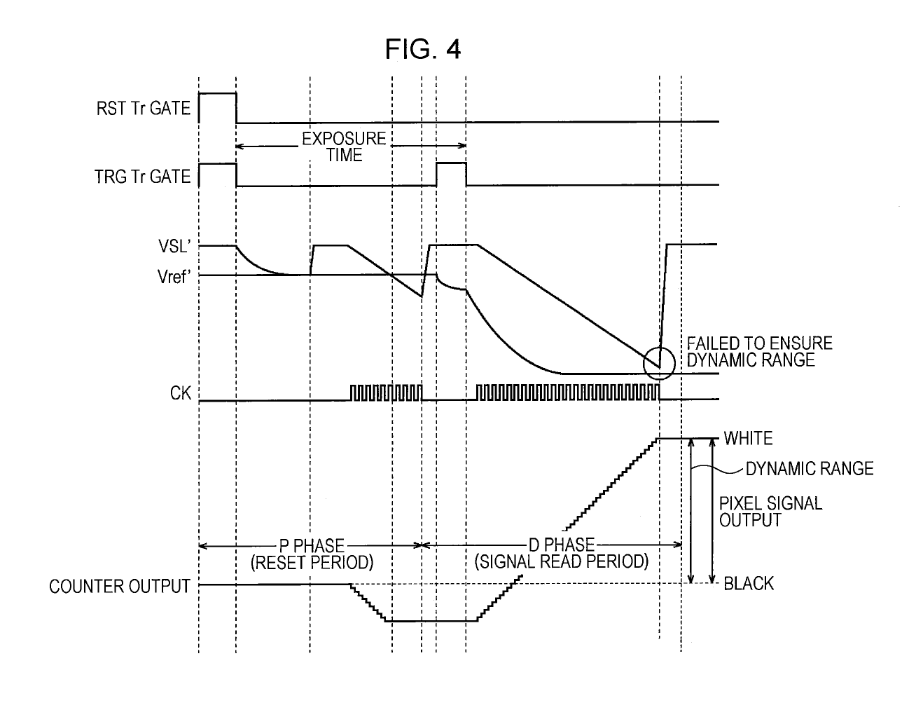

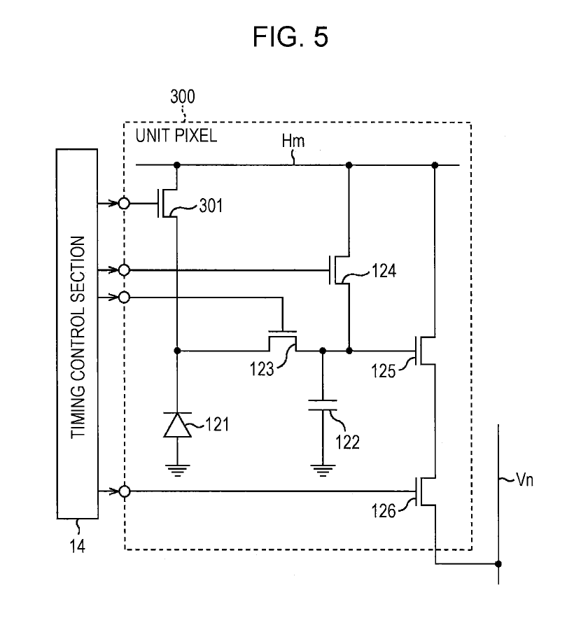

FIG. 5 illustrates an example of a configuration of a unit pixel 300, which can replace the unit pixel 111 (FIG. 2) in the CIS 10 illustrated in FIG. 1, according to the present embodiment.

The unit pixel 300 is capable of suitably adjusting an exposure time period to be shorter than the read period of the pixel reset level, for example, in the case of shooting a high-luminance subject.

As is apparent from the comparison between the unit pixel 300 in FIG. 5 and the unit pixel 111 in FIG. 2, the unit pixel 300 is produced by adding a RSTP Tr 301 to the configuration of the unit pixel 111 in FIG. 2. In this regard, same reference numerals are added to components other than the RSTP Tr 301 as those in FIG. 2.

That is to say, the unit pixel 300 includes the PD 121, the FD 122, the TRG Tr 123, the RST Tr 124, the Amp Tr 125, the SEL Tr 126 of the unit pixel 111, and the PD reset transistor (hereinafter RSTP Tr) 301.

The PD 121 performs photoelectric conversion on incident light to generate photoelectric charge, and stores the photoelectric charge. The FD 122 performs voltage conversion on the photoelectric charge transferred from the PD 121 through the TRG Tr 123. The TRG Tr 123 transfers the photoelectric charge stored in the PD 121 to the FD 122 under the control of the timing control section 14. The RST Tr 124 resets the potential of the FD 122 under the control of the timing control section 14.

The Amp Tr 125 amplifies the potential of the FD 122 under the control of the timing control section 14. The SEL Tr 126 outputs a voltage signal indicating the amplified potential of the FD 122 to the vertical signal line Vn under the control of the timing control section 14.

The RSTP Tr 301 directly resets the charge stored in the PD 311 under the control of the timing control section 14.

### Operation of Unit Pixel 300

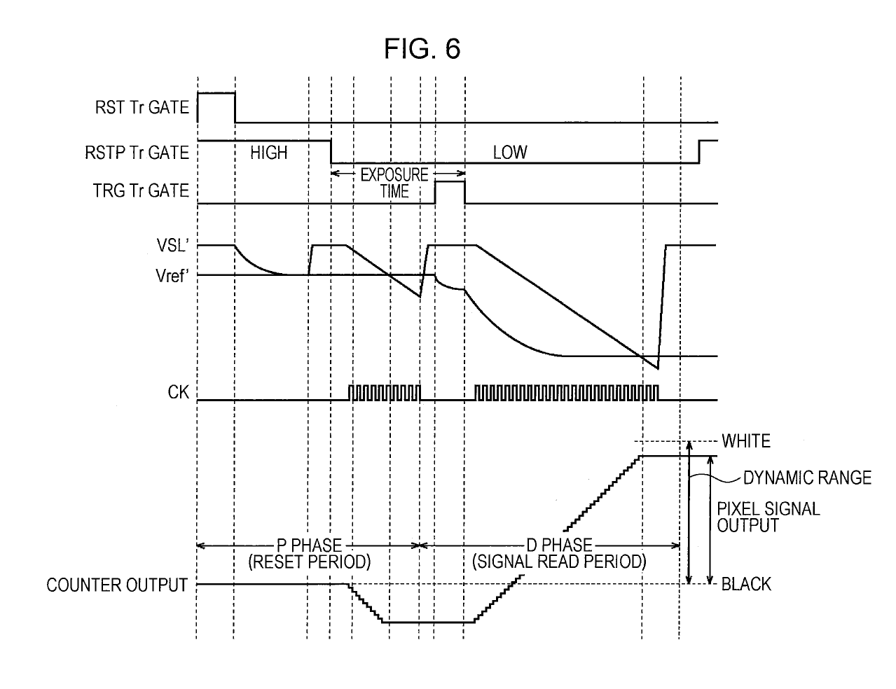

FIG. 6 illustrates an example of an operation waveform of the unit pixel 300 illustrated in FIG. 5.

In the unit pixel 300, the TRG Tr 123 and the RST Tr 124 are turned Low so that a pixel reset level is read. And while the pixel reset level is being read (during the TRG Tr 123 and the RST Tr 124 are Low), the RSTP Tr 301 is turned from High to Low, and thereby an exposure time period (shutter operation) is started.

In this manner, by switching the RSTP Tr 301, it is possible to adjust the exposure time period to be shorter than the read period of the pixel reset level. Accordingly, by controlling the RSTP Tr 301 in accordance with the luminance of a subject, it is possible to suitably set the exposure time period, and to ensure the dynamic range of the image signal.

### Variations

Next, a description will be given of variations of the unit pixel 300.

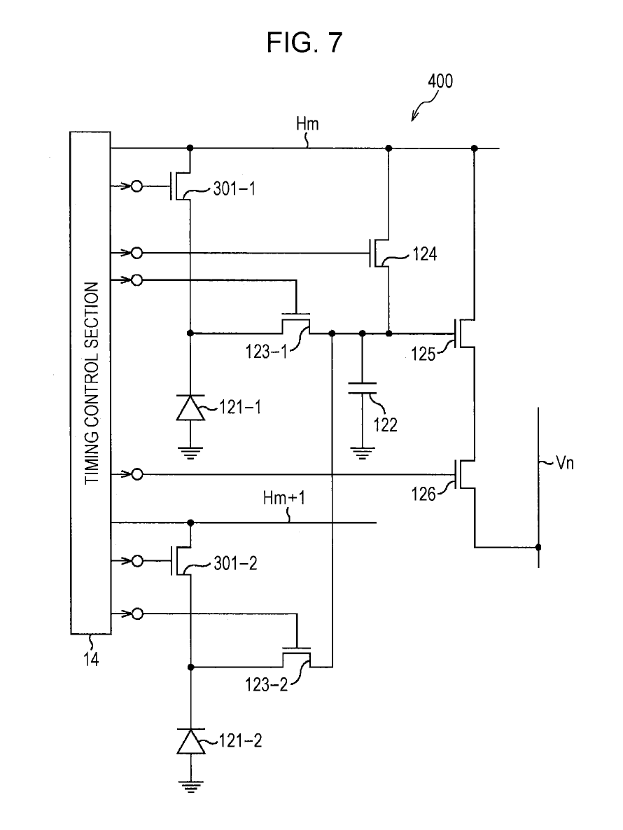

FIG. 7 illustrates an example of a configuration a unit pixel 400 in which photoelectric charges stored in a plurality of PDs 121 are transferred to the common FD 122.

In this regard, FIG. 7 illustrates the case where photoelectric charges stored in the two PDs 121-1 and 121-2 are transferred to the common FD 122. However, the number of PDs 121 that share the FD 122 may be two or more. Also, in FIG. 7, a same reference numeral is given to a component common to that in FIG. 5, and the description thereof will be omitted.

As illustrated in FIG. 7, by sharing the FD 122 among a plurality of PDs 121, it is possible to reduce the area of the unit pixel. Also, the photoelectric charges of a plurality of PDs 121 are added by the FD 122 so that the pixel signals of a plurality of rows are read at the same time, and thus it becomes possible to shorten the read time, and to ensure the signal level in the case of a low-luminance subject. Also, it is possible to fill the FD 122 with charge even if the exposure time period is shortened in the case of a high-luminance subject.

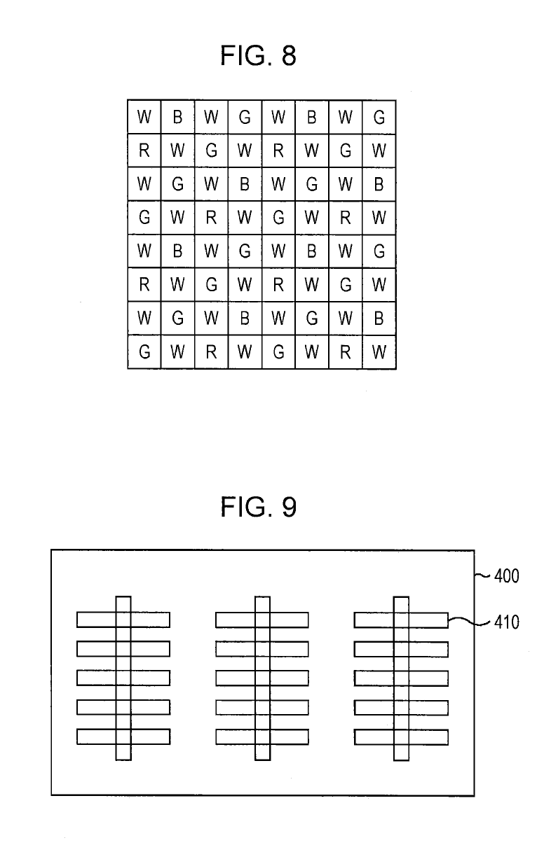

The configuration of the unit pixel illustrated in FIG. 7 is suitable for use in a CIS including a color filter in which W (white) is added to the three primary colors (R, G, and B) as illustrated in FIG. 8, for example, to ensure the luminance of the entire image to be captured.

Also, the configuration of the unit pixel illustrated in FIG. 7 is suitable for use in a pixel array 400 at the time of operating in a monitoring mode, in which AF (Auto Focus) line sensors 410 are distributedly disposed on the entire screen as illustrated in FIG. 9.

In this regard, it is possible to apply a CIS including the unit pixel 300, which is an embodiment of the present disclosure, and the unit pixel 400, which is a variation thereof, to all the electronic apparatuses having an imaging function.

An embodiment of the present disclosure is not limited to the above-described embodiments, and various changes are possible without departing from the spirit and scope of the present disclosure.

The present disclosure contains subject matter related to that disclosed in Japanese Priority Patent Application JP 2012-142959 filed in the Japan Patent Office on Jun. 26, 2012, the entire contents of which are hereby incorporated by reference.

What is claimed is:

1. A solid-state imaging device comprising:
a photoelectric conversion section configured to perform photoelectric conversion on incident light, and to store obtained photoelectric charge;
a voltage conversion section configured to convert the photoelectric charge transferred from the photoelectric conversion section into a voltage signal;
a first gate section configured to transfer the photoelectric charge stored in the photoelectric conversion section to the voltage conversion section;
a second gate section configured to reset a potential of the voltage conversion section;
a third gate section configured to directly reset the photoelectric charge stored in the photoelectric conversion section; and
a control section configured to control driving of the first to the third gate sections,
wherein the control section controls driving of the third gate section so as to adjust an exposure time of the photoelectric conversion section.

2. The solid-state imaging device according to claim 1,
wherein the control section is configured to set the third gate section to Low in order to start the exposure time of the photoelectric conversion section in a pixel-reset-level read period in which the first gate section and the second gate section are at Low.

3. The solid-state imaging device according to claim 2,
wherein the third gate section is controlled to be driven in accordance with luminance of a subject so that the exposure time of the photoelectric conversion section is adjusted.

4. The solid-state imaging device according to claim 2,
wherein a plurality of the photoelectric conversion sections and the first gate sections are provided, and
the voltage conversion section adds the photoelectric charges transferred from the plurality of the photoelectric conversion sections to convert the photoelectric charges into a voltage signal.

5. The solid-state imaging device according to claim 4, further comprising
a color filter configured to cover a pixel array section including a large number of photoelectric conversion sections disposed in a matrix,
wherein the color filter includes a white color.

6. The solid-state imaging device according to claim 4,
wherein the photoelectric conversion section is disposed on an AF line sensor.

7. A method of driving a solid-state imaging device including a photoelectric conversion section configured to perform photoelectric conversion on incident light, and to store obtained photoelectric charge, a voltage conversion section configured to convert the photoelectric charge transferred from the photoelectric conversion section into a voltage signal, a first gate section configured to transfer the photoelectric charge stored in the photoelectric conversion section to the voltage conversion section, a second gate section configured to reset a potential of the voltage conversion section, a third gate section configured to directly reset the photoelectric charge stored in the photoelectric conversion section, and a control section configured to control driving of the first to the third gate sections, the method comprising:
by the control section, setting the first gate section and the second gate section to Low to dispose a read period of a pixel reset level; and
setting the third gate section to Low in the read period of the pixel reset level in order to start an exposure time of the photoelectric conversion section.

8. An electronic apparatus including an imaging section using a solid-state imaging device,
the solid-state imaging device comprising:
a photoelectric conversion section configured to perform photoelectric conversion on incident light, and to store obtained photoelectric charge;
a voltage conversion section configured to convert the photoelectric charge transferred from the photoelectric conversion section into a voltage signal;
a first gate section configured to transfer the photoelectric charge stored in the photoelectric conversion section to the voltage conversion section;
a second gate section configured to reset a potential of the voltage conversion section;
a third gate section configured to directly reset the photoelectric charge stored in the photoelectric conversion section; and
a control section configured to control driving of the first to the third gate sections,
wherein the control section controls driving of the third gate section so as to adjust an exposure time of the photoelectric conversion section.
